(19) United States
(12) Patent Application Publication
(10) Pub. No.: US 2006/0293436 A1
(43) Pub. Date: Dec. 28, 2006

(54) Glass like material with improved safety characteristics

(76) Inventor: Ralph McNeill, East Kilbride (GB)

Correspondence Address: FLESHNER & KIM, LLP, P.O. BOX 221200, CHANTILLY, VA, 20153, US

(21) Appl. No.: 10/571,603

(22) PCT Filed: Aug. 31, 2004
(86) PCT No.: PCT/GB04/03647

§ 371 Date: Mar. 10, 2006

(30) Foreign Application Priority Data
Sep. 11, 2003 (GB) 0321287.5
Sep. 11, 2003 (GB) 0321286.7

(51) Int. Cl. C08G 18/42

(52) U.S. Cl. 524/500

(57) ABSTRACT

A material which can be used as a substitute for ordinary glass comprises a blend of a rigid and normally brittle amorphous thermoplastic material with one or more compatible low molecular weight resins. The material when broken, breaks into fragments which are not sharp and do not injure. A container having improved safety characteristics can be manufactured from the material and has many characteristics similar to an ordinary glass bottle—i.e. clarity, rigidity and brittleness. However when broken, the bottle shatters into fragments which are harmless and cannot be used to cut or pierce human skin.

The present invention relates to a glass-like material which has improved safety characteristics compared to ordinary glass.

In the present Application references to a “glass-like” material refer to a material having the following characteristics; clarity, brittleness, low strain to failure and rigidity.

Ordinary glass is used in a variety of everyday applications. For example it is known in the art to use glass as a protective covering over fire and other types of emergency alarms, emergency door releases, emergency stop buttons on public transport, fire extinguishers, fire axes and the like. As glass is transparent persons can quickly and easily identify the presence of the alarm or apparatus in the retaining box. If required, the glass can be broken in order to access the alarm or device.

However an inherent problem lies in the manner in which the glass can be broken. Often a subsidiary device such as a hammer is supplied with, or near to, the alarm or apparatus, and can be used to break the glass. However, in the event that this device is missing or cannot be located in an emergency situation it will be necessary for the person who wishes to access the apparatus or alarm to break the glass by some other means. In the event of an emergency situation the person may use, for example, a hand or elbow for this purpose, and may, as a result, sustain injuries from breaking the glass. Breakage of glass results in the production of sharp glass fragments and splinters, which can cause injury to the user or other persons in the proximity of the alarm or apparatus. In addition the potential risk of injury from breaking the glass may cause hesitation on the part of the person who wishes to access the alarm or apparatus, having dangerous consequences.

The glass may also be broken by malicious or accidental damage. Whilst the glass fragments can be removed and the retaining glass replaced, there is an interim risk of injury to persons coming into contact with the broken fragments.

Considerable research has been conducted to find materials which can be used in Applications similar to glass but which minimise the risk of damage to persons in the instance of the material being broken either intentionally or accidentally. Safety glass i.e. toughened glass, materials are well known in the art and have numerous applications and uses. Most have enhanced safety by virtue of being reinforced in strength, such that they have a higher stress to failure than glass; in other words a greater force is needed to shatter or break them than would be required with ordinary glass. Uses vary from windows and doors on automobiles and public transport, to domestic uses such as shower enclosures and room partitions. Whilst in many instances these have greatly increased safety, they are of limited use in Applications where it is actually desirable for the glass to be broken, i.e. when used on retaining boxes of emergency apparatus and alarms, because of their enhanced strength and resistance to force.

For example the polymeric materials Perspex™ and Plexiglas™, are transparent like glass, and do not pose the same risk of injury when broken. However, these materials can be harder to break than glass and can still produce sharp fragments when broken.

In addition, the containers in which alcoholic drinks, carbonated soft drinks and oxygen sensitive juices are sold are also traditionally manufactured from glass. Glass bottles are well received by consumers as they impart the impression of a high quality product and have “chink factor”. Nevertheless, the use of bottles is inherently dangerous, as glass is easily broken. It will be appreciated that this is a particular problem in bars, pubs and nightclubs, where accidental breakage of glass bottles, is a potential health risk.

Glass bottles are also disliked as they can be used deliberately, as weapons, to inflict damage on other persons. In fact, safety regulators have actively encouraged drinks manufacturers, as well as establishments which serve drinks and alcohol, to use bottles and glasses made from non-dangerous materials, in order to reduce the number of serious injuries caused by glass and bottle attacks.

In recent years there has been a move towards providing bottles manufactured from materials which are not as dangerous as glass. It is estimated that packaged beer production world wide in 1996 was 106.6 billion litres, requiring 186.2 billion bottles and 73.7 billion cans. The beer bottle marker was forecasted to grow at an annual rate of three percent through 2001 to 216 billion units. Most bottle production makes use of glass with only 0.1 billion plastic bottles being utilised in 1996. However due to the push towards increased safety it is estimated that the demand for plastic bottles is forecast to reach 2.5 billion by 2006.

The focus on safer bottles is particularly important with respect to alcoholic drinks, which are consumed in bars and nightclubs. PET, poly(ethylene terephthalate), a plastic which can be readily manufactured into bottles, and which does not break as readily as glass, has already been used for this purpose.

However the use of PET poses its own problems to the industry. PET is a relatively expensive material and not cheap to process which makes it a less popular option for drinks manufacturers. In addition, there is a general consensus that plastic bottles are not as well received by the public as they feel cheaper and do not have the same high quality feel as glass.

It is therefore an object of at least one aspect of the present invention to provide a material which resembles glass, but which has improved safety characteristics when compared to ordinary glass.

It is also an object of at least one aspect of the present invention to overcome the problems that are described above with reference to existing glass and plastic bottles.

According to a first aspect of the present invention there is provided a material which shatters, when broken, into fragments which do not cut, puncture or otherwise damage human skin or tissue, wherein the material is comprised of an amorphous thermoplastic polymer and one or more low molecular weight resins.

Preferably the material is comprised of a simple mixture of amorphous thermoplastic polymer and one or more low molecular weight resins.

Preferably the amorphous thermoplastic polymer is chosen from the group consisting of polystyrene (PS), polymethyl methacrylate (PMAA), styrene-acrylonitrile copolymer (SAN), linear polyesters and co-polyesters and polycarbonate (PC).

The one or more low molecular weight resins chosen will be completely compatible with the chosen polymer. For example in the case of polystyrene the low molecular weight resin is typically C9 aromatic hydrocarbon resin.

Preferably the material has a tensile stress limit of between 11 and 60 Nmm⁻².

Preferably the low molecular weight resin will have a Mn (number average molecular weight) such that it has less than 500 repeating units, and preferably less than 50 repeating units.

The material may be manufactured in sheet form.

According to a second aspect of the present invention there is provided a polymeric blend comprising a polymer selected from the group consisting of: polystyrene, (PS), polymethyl methacrylate (PMAA), styrene-acrylonitrile copolymer (SAN), linear polyesters and co-polyesters and polycarbonate (PC) and one or more low molecular weight resins.

The one or more low molecular weight resins chosen will be completely compatible with the chosen polymer. For example in the case of polystyrene the low molecular weight resin is typically C9 aromatic hydrocarbon resin.

Preferably the one or more low molecular weight resins have a Mn (number average molecular weight) such that it has less than 500 repeating units, and preferably less than 50 repeating units. Preferably the one or more low molecular weight resins are hydrocarbon resins.

Preferably the one or more low molecular weight resins are aromatic hydrocarbon resins.

The polymeric blend may be manufactured in sheet form.

According to a third aspect of the present invention there is provided a material which shatters, when broken, into fragments which do not cut, puncture or damage human skin or tissue, the material being comprised of polystyrene and one or more low molecular weight resins.

Preferably the material is comprised of a simple mixture of polystyrene and one or more low molecular weight resins.

Preferably the one or more low molecular weight resins are hydrocarbon resins.

Preferably the one or more low molecular weight resins are aromatic hydrocarbon resins.

Most preferably the one or more low molecular weight hydrocarbon resins are C9 aromatic hydrocarbon resins.

Preferably the one or more low molecular weight resins are, or are derived from, alpha methyl styrene.

Preferably the one or more low molecular weight hydrocarbon resins are selected from a group consisting of; Norsolene™, Kristalex™, Plastolyn™Endex™, Piccotex™, Piccolastic™, Sukorez™ or Arkon™.

Most preferably the one or more low molecular weight hydrocarbon resins are selected from a group consisting of; Norsolene W90™, Norsolene W100™, Norsolene W110™, Kristalex F85™, Kristalex F100™, Kristalex F115™, Plastolyn 240™, Plastolyn 290™, Endex 155™, Piccolastic D125™, Sukorez 100™, Sukorez 120™, Arkon P100™, Arkon P125™, Arkon P140™, Piccotex 75™, Piccotex 100™ or Piccotex 120™.

Preferably the one or more low molecular weight resins will have a Mn (number average molecular weight) such that it has less than 500 repeating units, and preferably less than 50 repeating units.

Preferably the material has a tensile stress limit between 11 and 60 Nmm⁻².

Optionally the material may also include UV inhibitors, antioxidants, flow modifiers, fire retarding agents, colour pigments and brighteners as known in the art.

The material may be manufactured in sheet form.

According to a fourth aspect of the present invention there is provided a method of manufacturing a material which shatters, when broken, into fragments which do not cut, puncture or damage human skin or tissue, the method comprising the step of mixing an amorphous thermoplastic polymer and one or more low molecular weight resins.

Preferably the amorphous thermoplastic polymer is chosen from the group consisting of polystyrene (PS), polymethyl methacrylate (PMAA), styrene-acrylonitrile copolymer (SAN), linear polyesters and co-polyesters and polycarbonate (PC).

Preferably the one or more low molecular weight resins are completely compatible with the chosen polymer. For example in the case of polystyrene preferably the chosen low molecular weight resin is C9 aromatic hydrocarbon resin.

Preferably the one or more low molecular weight resins are hydrocarbon resins.

Preferably the one or more low molecular weight resins are aromatic hydrocarbon resins.

Preferably the low molecular weight resin will have a Mn (number average molecular weight) such that it has less than 500 repeating units, and preferably less than 50 repeating units.

Preferably as the polystyrene is mixed with the one or more low molecular weight hydrocarbon resins, the glass transition temperature (T_{g}) of the material is elevated. Typically the Tg is elevated to 5-10 degress C. higher than the base polymer.

According to a fifth aspect of the present invention there is provided a method of manufacturing a material which shatters, when broken, into fragments which do not cut, puncture or damage human skin or tissue, the method comprising the step of mixing polystyrene and one or more low molecular weight hydrocarbon resins.

Preferably the one or more low molecular weight resins are hydrocarbon resins.

Preferably the one or more low molecular weight resins are aromatic hydrocarbon resins.

Most preferably the one or more low molecular weight hydrocarbon resins are C9 aromatic hydrocarbon resins.

Preferably the one or more low molecular weight resins are, or are derived from, alpha methyl styrene.

Preferably the one or more low molecular weight hydrocarbon resins are selected from a group consisting of; Norsolene™, Kristalex™, Plastolyn™ Endex™, Piccotex™, Piccolastic™, Sukorez™ or Arkon™.

Most preferably the one or more low molecular weight hydrocarbon resins are selected from a group consisting of; Norsolene W90™, Norsolene W100™, Norsolene W110™, Kristalex F85™, Kristalex F100™, Kristalex F115™, Plastolyn 240™, Plastolyn 290™, Endex 155™, Piccolastic D125™, Sukorez 100™, Sukorez 120™, Arkon P100™, Arkon P125™, Arkon P140™, Piccotex 75™, Piccotex 100™ or Piccotex 120™.

Preferably the low molecular weight resin will have a Mn (number average molecular weight) such that it has less than 500 repeating units, and preferably less than 50 repeating units.

The method may comprise the optional step of adding an additive selected from the group consisting of UV inhibitors, antioxidants, flow modifiers, fire retarding agents, colour pigments and brighteners as known in the art.

Preferably as the polystyrene is mixed with the one or more low molecular weight hydrocarbon resins, the glass transition temperature (T_{g}) of the material is elevated. Typically the Tg is elevated to 5-10 degress C. higher than the base polymer.

According to a sixth aspect of the present invention, there is provided a container manufactured from a material that shatters when broken into fragments which do not cut, puncture or otherwise damage human skin or tissue.

The container may be a bottle, glass, tumbler, or the like.

Preferably the material is comprised of an amorphous thermoplastic polymer and one or more low molecular weight resins.

Preferably the amorphous thermoplastic polymer is chosen from the group consisting of: polystyrene (PS), styrene-acrylonitrile co-polymer (SAN), linear polyesters and co-polyesters polycarbonate (PC).

Preferably the one or more low molecular weight resins are hydrocarbon resins.

Preferably the one or more low molecular weight resins are aromatic hydrocarbon resins

The one or more low molecular weight resins chosen will be completely compatible with the chosen polymer. For example, in the case of polystyrene, the low molecular weight resin will typically be C9 aromatic hydrocarbon resin.

Preferably the material has a tensile stress limit between 11 and 60 Nmm².

Preferably the one or more low molecular weight hydrocarbon resins are selected from a group consisting of: Norsolene™, Krystalex™, Plastolyn™, Endex™, Piccotex™, Piccolastic™, Sukorez™, Arkon™

Most preferably the one or more low molecular weight hydrocarbon resins are selected from a group consisting of; Norsolene W90™, Norsolene W100™, Norsolene W110™, Kristalex F85™, Kristalex F100™, Kristalex F115™, Plastolyn 240™, Plastolyn 290™, Endex 155™, Piccolastic D125™, Sukorez 100™, Sukorez 120™, Arkon P100™, Arkon P125™, Arkon P140™, Piccotex 75™, Piccotex 100™ or Piccotex 120™.

Preferably the low molecular weight resin will have a \overline{Mₙ} (number average molecular weight) such that it has less than 500 repeating units, and preferably less than 50 repeating units.

The container may be manufactured from the material using injection blow moulding and/or injection stretch blow moulding techniques.

Alternatively, the container may be manufactured from the material using extrusion blow moulding.

Optionally the material of the container may also comprise a oxygen barrier. The material of the container may also comprise oxygen scavengers.

The barrier included in the material of the container may be selected from the group consisting of: acrylonitrile-methyl acrylate copolymer, ethylene vinyl alcohol (EVOH) or nylon MXD6.

Preferably the barrier is Barex™. Most preferably the barrier is Barex™ 210 or Barex™ 218.

In the embodiment where nylon MXD6 is used as a barrier, the oxygen scavenger may be X-312. Amosorb 3000, or a scavenger of MXD6 with metal catalysed oxygen reduction chemistry may also be used.

The barrier may be overmoulded or sprayed onto the container or alternatively may be included in the material of the container, using co-injection techniques.

The container may also have an inorganic coating. This may be a thin layer of amorphous carbon. The inorganic coating may be applied to the inside surface of the container. Typically the inorganic coating will be applied in a layer of 100 to 200 nm thickness. The layer may be applied by spraying.

The container may also have an external organic coating. The external organic coating may be PVDC or a two component epoxyamine.

The container may be manufactured from multiple layers of the material. Two or more layers of the container may be combined to act as an improved oxygen barrier.

Optionally the material of the container may also include UV inhibitors, antioxidants, flow modifiers, colour pigments and brighteners as known in the art.

Preferably as the amorphous thermoplastic polymer is mixed with the one or more low molecular weight hydrocarbons, the glass transition temperature is elevated. Preferably the material of the container has a glass transition temperature of above 80° C.

The material herein described can be used as a substitute for ordinary glass. The material is glass-like in character having clarity, brittleness, low strain to failure and rigidity. The material has a variety of uses including application as enclosures and boxes to house emergency equipment e.g. keys, first aid boxes, fire extinguisher, window hammers, emergency stop buttons, emergency kick out panels and alarms, as well as use in access panels, windows and doors. It should be recognised that the abovedescribed uses are by way of example only and are not intended to limit the manner in which the material is used. The material can be manufactured in sheet form, by extrusion, and moulded into any shape by injection moulding or other standard melt processes.

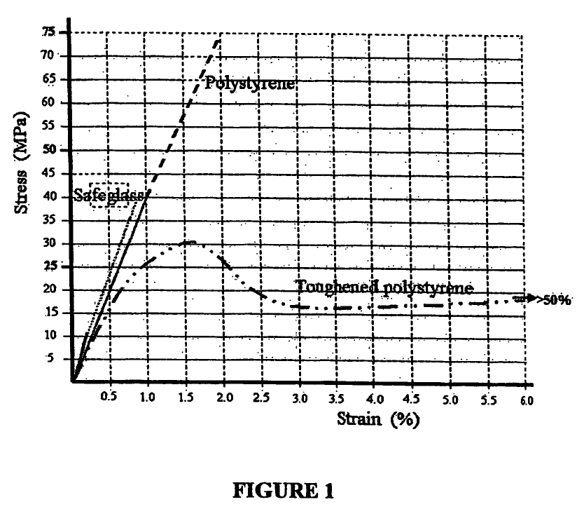

Table 1 shows the stress-strain behaviour of the material in comparison to other polystyrene materials. FIG. 1 shows this information in the form of a graph.

TABLE
Comparison of Properties of Safeglass ™ to Polystyrenes.

| | | Yield | | Stress | | Vicat |
|---|---|---|---|---|---|---|
| | Modulus/ | stress/ | Yield | at break/ | Strain | softening |
| Polymer Type: | GPa | MPa | strain/% | MPa | at break/% | temperature |
| Polystyrene | 3.0-3.2 | Brittle - no yield | | 4-75 | 2 | 82-98 |
| (i.e. “crystal” | | | | | | |
| or GPPS) | | | | | | |
| Toughened | 1.6-2.4 | 18-38 | 1.5 | < yield | 15->50 | 76-95 |
| polystyrene | | | | | | |
| (e.g. HIPS) | | | | | | |

| Safeglass ™ | 3.1-3.4 | Brittle - no yield | 8-40 | 1-2 | 95-104 |
|---|---|---|---|---|---|
| N.B. Safeglass ™ materials are slighly more rigid and certainly more brittle than conventional “crystal”polystyrene. Modified polystyrenes are invariably less rigid and tougher materials as a result of blending with a rubbery (low T_{g}) additive. This also results in a lowering of the Glass Transition Temperature (T_{g}) as witnessed by the reduction in the Vicat Softening Temperature. The reverse is true of | | | | | |
| # Safeglass ™ materials which show no such decrease in T_{g}, indeed it can be higher than the critical temperature. | | | | | |

The material is fundamentally a blend of a rigid and normally brittle amorphous thermoplastic with a glass transition temperature Tg at least 5° C. above ambient and one or more compatible low molecular weight resins.

An example embodiment will now be described by way of example only.

A rigid and normally brittle amorphous thermoplastic polymer is blended with one or more low molecular weight resins which have a Mn (number average molecular weight) such that the resin has less than 500 repeating units, preferably less than 50 repeating units. The one or more low molecular weight resins have a weight average molecular weight of 6050 or below.

The material is manufactured by mixing or blending a clear polymer with one or more low molecular weight hydrocarbon resins. The polymer is an amorphous thermoplastic and can be chosen from the group of polystyrene, (PS), polymethyl methacrylate (PMAA), styrene-acrylonitrile copolymer (SAN), linear polyesters and co-polyesters and polycarbonate (PC). It is important that the low molecular weight resin is completely compatible with the chosen polymer. For example in the case of polystyrene it is C9 aromatic hydrocarbon resin.

In the herein described embodiment polystyrene is used. The one or more low molecular weight resins which are mixed with the polystyrene are aromatic hydrocarbon resins and typically C9 aromatic hydrocarbon resins. The one or more resins are typically alpha methyl styrene or vinyl toluene or derivatives thereof. These are selected from the following group: Norsolene W90™, Norsolene W100™, Norsolene W110™, Kristalex F85™, Kristalex F100™, Kristalex F115 ™, Plastolyn 240™, Plastolyn 290™, Endex 155™, Piccolastic D125™, Sukorez 100™, Sukorez 120™, Arkon P100™, Arkon P125™, Arkon P140™, Piccotex 75™, Piccotex 100™ or Piccotex 120™.

It has been discovered that by blending polystyrene with one or more of the abovementioned low molecular weight hydrocarbon resins, a hard, rigid material is formed which has the appearance and feel of glass, but which is extremely brittle and has low strain to failure. The material also has the inherent advantage that when broken, unlike glass, the material breaks into fragments which are not sharp and do not injure skin or tissue. The material is, by design, manufactured to break between 11 and 60 Nmm⁻². Therefore the material, when provided as a substitute to glass, for example in retaining boxes for emergency devices and alarms, can easily be broken by a human hand, fist, elbow, foot or the like and advantageously shatters into fragments or pieces which are not sharp and are not capable of cutting or puncturing human skin. Due to the inherent advantages of the material it is envisaged that it may have a variety of other uses, for example it may have application in novelty toys, such as stress relief toys, or have uses in “stunt” apparatus in, for example, theatres, shows or on film sets.

The material is manufactured by conventional melt compounding techniques. As the polystyrene is mixed with the one or more low molecular weight hydrocarbon resins, the glass transition temperature (T_{g}) of the material is elevated as the low molecular weight resin does not have a plasticising effect, the opposite effect is seen as the glass transition temperature of the material is elevated.

The material is generally transparent or clear, however dyes may be added to change the appearance of the material.

Low molecular weight in resins is a function of the length of the chains in the resin. In this case the hydrocarbon resins have a very low molecular weight, too low in fact for the resins to be of any use on their own, and are difficult to mould. By mixing low molecular weight hydrocarbon resin with polystyrene, the stress limit of the polystyrene is reduced giving the material the characteristics described in the present Application. Preferably the low molecular weight resin will have a Mn (number average molecular weight) such that it has less than 500 repeating units, and preferably less than 50 repeating units.

The following is an example of the material of the present invention.

### EXAMPLE 1

In order to achieve a material with a stress limit of 24 Mpa, a 50% mix of polymer and 50% resin is used, which acheieves this stress limit. Typically the polymer could be crystal polystyrene such as Polystyrol™ 143E, and resin Plastolyn™ 240.

### EXAMPLE 2

In order to achieve a material with a stress limit of 34 Mpa, a 60% mix of polymer and 40% resin is used, which acheieves this stress limit. Typically the polymer could be crystal polystyrene such as Polystyrol™ 143E, and resin Plastolyn™ 240.

A container having improved safety characteristics can be manufactured from the material comprised of an amorphous thermoplastic polymer and one or more resins. The resins are aromatic hydrocarbon resins and are selected from a group consisting of Norsolene™, Krystalex™, Plastolyn™, Endex™, Sokorez™, Arkon™, Piccolastic™ and Piccotex™, and in particular Norsolene W90™, Norsolene W100™, Norsolene W110™, Kristalex F85™, Kristalex F100™, Kristalex F115™, Plastolyn 240™, Plastolyn 290™, Endex 155™, Piccolastic D125™, Sukorez 100™, Sukorez 120™, Arkon P100™, Arkon P125™, Arkon P140™, Piccotex 75™, Piccotex 100™ or Piccotex 120™. In a particular embodiment the one or more low molecular weight resins are C9 hydrocarbon resins with an \overline{Mₙ} (number average molecular weight) such that it has less than 500 repeating units and preferably less than 50 repeating units. The resin or resins chosen will be selected on compatibility with the chosen polymer.

Low molecular weight in resins is a function of the length of the chains in the resin. In this case the hydrocarbon resins have a very low molecular weight, too low in fact for the resins to be of any use as a structural plastics material on their own, and are difficult to mould. By mixing low molecular weight hydrocarbon resin with polystyrene, the stress limit of the polystyrene is reduced giving the material the characteristics described in the present Application.

The amorphous thermoplastic polymer is chosen from the group consisting of polystyrene (PS, styrene-acrylonitrile co-polymer (SAN), linear polyesters and co-polyesters and polycarbonate (PC). These can be mixed, blended or polymerised with the one or more low molecular weight resins. UV inhibitors, dyes, antioxidants, flow modifiers, colour pigments and brighteners can also be added to change or adapt the appearance of the container.

The container herein described has many characteristics similar to an ordinary glass bottle—i.e. clarity, rigidity and brittleness. However when broken, the bottle shatters into fragments which are harmless and cannot be used to cut or pierce human skin.

The material used to manufacture the container is fundamentally a blend of a rigid and normally brittle amorphous thermoplastic with a glass transition temperature Tg at least 50° C. above ambient and one or more compatible low molecular weight resins. A rigid and normally brittle amorphous thermoplastic polymer is blended with one or more low molecular weight resins which have a \overline{Mₙ} (number average molecular weight) such that the resin has less than 500 repeating units, preferably less than 50 repeating units. The one or more low molecular weight resins have a weight average molecular weight of 6050 or below. The material is, by design, manufactured to break between 11 and 60 Nmm⁻².

The material can be heated and made into the desired shape of the container, i.e. a bottle, glass or tumbler, by any suitable technique known to the art e.g. injection moulding, extrusion blow moulding or pre-form injection blow moulding techniques.

The container may be manufactured from one or more layers of the material. More than one layer may be used to provide improved oxygen barrier characteristics. Alternatively the container may be coated with an oxygen barrier. Conventional coating technologies can be broadly divided into two categories. The first are those that use vacuum or plasma routes to deposit very thin films of materials, such as carbon or silica, onto the surface of the article being coated. The second, rely on the atomised spraying of liquid organic materials onto the external surfaces of the bottle. Ideally all coating materials must not interfere with the economics of recycling, nor detract from the bottle's appearance, but a significant further consideration with thin film internal deposits is the need for the materials to be approved for food contact.

As the container described herein is manufactured from the material at lower processing materials than conventional plastics, barriers which are not usually suitable for this purpose can be used. For example the container can be coated in Barex™ (acrylonitrile-methyl acrylate copolymer), and in particular Barex™ 210 or Barex™ 218, which has high oxygen barrier properties. This can be achieved either by overmoulding, spraying or co-injection techniques. The barrier could alternatively be acrylonitrile-methyl acrylate copolymer, ethylene vinyl alcohol (EVOH) or nylon MXD6. The barrier could be provided on the inside or outside of the container.

Oxygen scavengers such as all polyester Amosorb 3000 or X-312 scavenger may be used. These Oxygen scavenging materials can be incorporated into the material of the container to react with the gas before it reaches the contents. Amosorb 3000 or X-312 scavenger have particular application when the barrier selected is MXD6 nylon. With these types of active oxygen scavenging packages, shelf life performance is determined solely by the rate of carbonation loss and CO₂ loss is reduced by the presence of the MXD6 as a physical barrier. A scavenger of MXD6 with metal catalysed oxygen reduction chemistry may also be used (Oxbar). This system reacts very quickly with oxygen in the container and has a high oxygen capacity, ensuring a long active life.

The container may also have an inorganic coating such as amorphous carbon. This can be sprayed onto the surface of the container being coated. The inorganic coating can be applied either to the inside or outside of the bottle after blowing. Plasma-applied coatings, using carbon or silicon, which have recently been developed, may be used. The Sidel Actis™ and Kirin DLC™ coating technologies can be used produce a thin layer of amorphous carbon, typically 100 to 200 nm thick, on the inside surface of the container. This is deposited from a high-energy plasma of acetylene gas within a high vacuum environment. The coating provides an excellent barrier to both O₂ and CO₂, and, because it is on the inside of the container, prevents the O₂ dissolved in the material of the container from migrating into the contents of the container during the first few weeks of storage.

Because the deposited layers are fundamentally brittle, they have to be extremely thin in order not to flake off under container stresses, caused by bottle expansion and creep when the bottle is filled, and under pressure from the contents. Other factors include damage and scuffing due to bottle handling, but these clearly do not affect the integrity of the coating if it is on the inside. The barrier performance improvements of carbon coatings are similar to those achieved by organic coatings, again giving a longer potential retail shelf life of around nine months.

Silica technologies such as Glaskin and BestPet can also be used. These rely on the application of a SiOₓ vacuum plasma coating, to give a barrier layer between 40 and 60 nm thick. While the Glaskin process applies the glass clear coating to the inside of the bottle, the BestPet technique applies it to the outside.

As an alternative an organic coating may be used. External organic coatings have been known and used in the industry since the early 1980s. In the mid 1990s, barrier coating solutions based on two component epoxyamine chemistry (Bairocade) were developed, first to lengthen the shelf life of the smaller soft drink sizes in hotter climates, and then for beer. These provide a transparent, glossy, external spray coating which is an excellent barrier to migration of CO₂ and O₂, and is unaffected by humidity. The low temperature thermoset cure provides a tough film, robust to filling and handling conditions.

Typically the coating will be applied to the container at thicknesses between 6 μm and 10 λm, and allow the use of standard resins and preforms with existing injection and blow moulding equipment. The use of such coatings provides a performance improvement which is around 19 times better than an uncoated container and translates into a longer retail shelf life. The external organic coating may be PVDC two component epoxyamine.

The alternative approach to improving the gas permeation properties of the container material is to manufacture it from multiple layers of the material. In other words, two or more layers of the container may be combined to act as an improved oxygen barrier. Final shape blowing produces a bottle with up to seven different polymer layers, which either act as a physical barrier to gas permeation, or are chemically active in scavenging oxygen from the material of the container and intercepting oxygen diffusing in from outside.

The material herein described has an elevated glass transition temperature, which is much higher than the glass transition temperature of, for example, PET. PET has a glass transition temperature that is lower than the pasteurisation temperature used in the beer industry. As a result when PET is used in the manufacture of bottles, creep may occur during filling. In other words the material expands, which causes deformity of the bottle. This problem is eliminated using the material herein described as the glass transition temperature is above the pasteurisation temperature used during filling.

Furthermore, bottles made from PET are generally filled using flash pasteurisation, as opposed to full pasteurisation, which the industry prefers. Full pasteurisation is generally more efficient which results in a longer shelf life for the product. However full pasteurisation is not generally used with PET materials.

A particular advantage of the material herein described is that because it has an elevated glass transition temperature, it can withstand full pasteurisation.

It has been discovered that using the above described material a container such as a bottle, glass or tumbler can be manufactured which does not cut, puncture or otherwise damage human skin or tissue when broken. In other words, the container will shatter into harmless fragments, shards or pieces when broken.

A particular advantage of the container described herein, lies in the fact that even though it does not shatter into dangerous fragment when broken, it has a similar quality feel as glass, and has improved aesthetic qualities over existing plastics such as PET. The material herein described for use in manufacturing a container, is relatively light and glass-like to touch and as it is a polymer is can be processed, for example by including oxygen barriers during production. Importantly, the material is thicker than an equivalent PET bottle so has a more glass-like feel but can be manufactured into containers without an increase in cost.

Potential uses of the container are not limited. For example, the container may be used for beer, carbonated soft drinks, oxygen sensitive juices, beverages or milk

### EXAMPLE 1

An 85% mix of polystyrene polymer and 15% resin is used to manufacture a bottle with improved safety characteristics. The 15% resin maybe comprised of a single resin selected from the group consisting of Norsolene™, Krystalex™, Plastolyn™, Endex™, Sokorez™, Arkon™, Piccolastic™ and Piccotex™, or may be a combination of two or more of the above. Plastolyn™ is particularly suitable for this purpose. The resin or resins are selected to achieve a desired molecular weight range.

Further modifications and improvements may be added without departing from the scope of the invention herein intended.

1. A material which shatters, when broken, into fragments which do not cut, puncture or otherwise damage human skin or tissue, wherein the material is comprised of an amorphous thermoplastic polymer and one or more low molecular weight resins.

2. A material as claimed in claim 1 comprised of a simple mixture of amorphous thermoplastic polymer and one or more low molecular resins.

3. A material as claimed in claim 1 wherein the amorphous thermoplastic polymer is selected from the group consisting of polystyrene (PS), polymethyl methacrylate (PMAA), styrene-acrylonitrile copolymer (SAN), linear polyesters and co-polyesters and polycarbonate (PC).

4. A material as claimed claim 1 having a tensile stress limit between 11 and 60 Nmm-2.

5. A material as claimed in claim 1, wherein the low molecular weight resin has an Mn (number average molecular weight) such that it has less than 500 repeating units.

6. A material as claimed in claim 5 wherein the low molecular weight resin has an Mn (number average molecular weight) such that it has less than 50 repeating units.

7. A material as claimed claim 1 manufactured in sheet form.

8. A polymeric blend comprising a polymer selected from the group consisting of: polystyrene (PS), polymethyl methacrylate (PMAA), styrene-acrylonitrile copolymer (SAN), linear polyesters and co-polyesters and polycarbonate (PC) and one or more low molecular weight resins.

9. A polymeric blend as claimed in claim 8 wherein the one or more low molecular weight resins have an Mn (number average molecular weight) such that it has less than 500 repeating units.

10. A polymeric blend as claimed in claim 9 whenin the one or more low molecular weight resins have an Mn (number average molecular weight) such that it has less than 50 repeating units.

11. A polymeric blend as claimed in claim 8, wherein the one or more molecular weight resins are hydrocarbon resins.

12. A polymeric blend as claimed in claim 11 wherein the hydrocarbon resins are aromatic hydrocarbon resins.

13. A polymeric blend as claimed in claim 8 manufactured in sheet form.

14. A material which shatters, when broken, into fragments which do not cut, puncture or damage human skin or tissue, the material being comprised of polystyrene and one or more low molecular weight resins.

15. A material as claimed in claim 14 comprised of a simple mixture of polystyrene and one or more low molecular weight resins.

16. A material as claimed in claim 14, wherein the one or more low molecular weight resins are hydrocarbon resins.

17. A material as claimed claim 16 wherein the hydrocarbon resins are aromatic hydrocarbon resins.

18. A material as claimed in claim 17 wherein the aromatic hydrocarbon resins are C9 aromatic hydrocarbon resins.

19. A material as claimed in claim 14, wherein the one or more low molecular weight resins are, or are derived from, alpha methyl styrene.

20. A material as claimed in claim 14, wherein the one or more low molecular weight hydrocarbon resins are selected from a group consisting of; Norsolene™, Kristalex*″, Plastolyn™, Endex, Piccotex, Piccolastic, Sukorez or Arkon.

21. A material as claimed in claim 20 wherein the one or more low molecular weight hydrocarbon resins are selected from a group consisting of; Norsolene W901, Norsolene W100′, Norsolene W110™, Kristalex F851, Kristalex F100, Kristalex F115″, Plastolyn 240, Plastolyn 290, Endexl55 Piccolastic D125, Sukorez 100, Sukorez 120™, Arkon P100, Arkon P125™, Arkon P140™, Piccotex 75™, Piccotex 100 or Piccotex 120.

22. A material as claimed claim 14, wherein the one or more low molecular weight resins have an Mn (number average molecular weight) such that it has less than 500 repeating units.

23. A material as claimed in claim 22 wherein the one or more low molecular weight resins have an Mn (number average molecular weight) such that it has less than 50 repeating units

24. A material as claimed in claim 14 having a tensile stress limit between 11 and 60 Nmm-2.

25. A material as claimed in claim 14, which also includes one or more additives selected from the group including W inhibitors, antioxidants, flow modifiers, fire retarding agents, colour pigments and brighteners, and oxygen scavengers.

26. A material as claimed in claim 14, manufactured in sheet form.

27. A method of manufacturing a material which shatters, when broken, into fragments which do not cut, puncture or damage human skin or tissue, the method comprising the step of mixing an amorphous thermoplastic polymer and one or more low molecular weight resins.

28. A material as claimed in claim 27 wherein the amorphous thermoplastic polymer is chosen from the group consisting of polystyrene (PS), Polymethyl methacrylate (PMAA), styrene-acrylonitrile copolymer (SAN), linear polyesters and co-polyesters polycarbonate (PC).

29. A material as claimed in claim 27, wherein the one or more low molecular weight resins are hydrocarbon resins.

30. A material as claimed in claim 29 wherein the hydrocarbon resins are aromatic hydrocarbon resins.

31. A material as claimed in claim 27, wherein the low molecular weight resin has an Mn (number average molecular weight) such that it has less than 500 repeating units.

32. A material as claimed in claim 31 wherein the low molecular weight resin has an Mn (number average molecular weight) such that it has less than 50 repeating units.

33. A material as claimed in claim 27, wherein the glass transition temperature (Tg) of the material is elevated as the amorphous thermoplastic polymer is mixed with the one or more low molecular weight hydrocarbon resins.

34. A material as claimed in claim 33 when the Tg is elevated to 5-10° C. higher than the base polymer.

35. A method of manufacturing a material which shatters, when broken, into fragments which do not cut, puncture or damage human skin or tissue, the methods comprising the step of mixing polystyrene and one or more low molecular weight hydrocarbon resins.

36. A method as claimed in claim 35 wherein the one or more low molecular weight resins are hydrocarbon resins.

37. A method as claimed in claim 36 wherein the hydrocarbon resins are aromatic hydrocarbon resins.

38. A method as claimed in claim 36 wherein the aromatic hydrocarbon resins are C9 aromatic hydrocarbon resins.

39. A method as claimed in claim 35, wherein the one or more low molecular weight resins are, or are derived from, alpha methyl styrene.

40. A method as claimed in claim 35, wherein the one or more low molecular weight hydrocarbon resins are selected from a group consisting of; Norsolene, Kristalex, Plastolyn, Endex, Piccotex, Piccolastic, Sukorez or Arkon™.

41. A method as claimed in claim 40 wherein the one or more low molecular weight hydrocarbon resins are selected from a group consisting of Norsolene W90*″, Norsolene W100™, Norsolene W11™, Kristalex F85, Kristalex F100™, Kristalex Full5, Plastolyn 240™, Plastolyn 290, Endexl55, Piccolastic D125T″, Sukorez 100™, Sukorez 1201, Arkon P100™, Arkon P125™, Arkon P140™, Piccotex 75T″, Piccotex 100™ or Piccotex 120™.

42. A method as claimed as in claim 35, wherein the low molecular weight resin has an Mn (number average molecular weight) such that it has less than 500 repeating units.

43. A method as claimed in claim 42 wherein the low molecular weight resin has an Mn (number average molecular weight) such that it has less than 50 repeating units.

44. A method as claimed in claim 35, comprising the additional step of adding one or more additives selected from the group consisting of W inhibitors, antioxidants, flow modifiers, fire retarding agents, colour pigments and brighteners and oxygen scavengers as known in the art.

45. A method as claimed in claim 35, where the glass transition temperature (Tg) of the material is elevated as the polystyrene is mixed with one or more low molecular weight hydrocarbon resins.

46. A method as claimed in claim 45 wherein the Tg is elevated to 5 to 10° C. higher than the base polymer.

47. A container manufactured from a material that shatters when broken into fragments which do not cut, puncture or otherwise damage human skin or tissue.

48. A container as claimed in claim 47 which is a bottle.

49. A container as claimed in claim 47 which is a glass.

50. A container as claimed in claim 47 which is a tumbler.

51. A container as claimed in claim 47, wherein the material is a mixture of an amorphous thermoplastic polymer and one or more low molecular weight resins.

52. A container as claimed in claim 51 wherein the amorphous thermoplastic polymer is chosen from the group consisting of: polystyrene (PS), styrene-acrylonitrile co-polymer (SAN), linear polyesters and co-polyesters polycarbonate (PC).

53. A container as claimed in claim 51 wherein the one or more low molecular weight resins are hydrocarbon resins.

54. A container as claimed in A container as claimed in claim 53 wherein the one or more low molecular weight resins are aromatic hydrocarbon resins

55. A container as claimed in claim 53, wherein the one or more low molecular weight hydrocarbon resins are selected from a group consisting of: Norsolene™, Irystalex, Plastolyn™, Endex, Piccotex™, Piccolastic™, Sukorez™, Arkon

56. A container as claimed in claim 55 wherein the one or more low molecular weight hydrocarbon resins are selected from a group consisting of: Norsolene W90, Norsolene W100™, Norsolene W110, Kristalex F85, Kristalex F100, I<ristalex F115 Plastolyn 240™, Plastolyn 290, Endex 155 Piccolastic D125, Sukorez 100, Sukorez 120, Arkon P100™, Arkon P125™, Arkon P140™, Piccotex 75™, Piccotex 100 or Piccotex 120™.

57. A container as claimed in claim 51, wherein the low molecular weight resin will have a Mn (number average molecular weight) such that it has less than 500 repeating units.

58. A container as claimed in claim 51, wherein the low molecular weight resin will have a Mn (number average molecular weight) such that it has less than 50 repeating units.

59. A container as claimed in claim 47, wherein the material has a tensile stress limit between 11 and 60 Nmm.

60. A container as claimed in claim 47 manufactured using injection blow moulding and/or injection stretch blow moulding techniques.

61. A container as claimed in claim 47, manufactured using extrusion blow moulding.

62. A container as claimed in claim 47 wherein the material contains an oxygen barrier.

63. A container as claimed in claim 62 wherein the barrier included in the material is selected from the group consisting of: acrylonitrile-methyl acrylate copolymer, ethylene vinyl alcohol (EVOH) or nylon MXD6.

64. A container as claimed in claim 62 wherein the barrier is Barex.

65. A container as claimed in claim 64 wherein the barrier is Barex 210 or Barex 218.

66. A container as claimed in claim 62, wherein the barrier is overmoulded or sprayed onto the container.

67. A container as claimed in claim 62, wherein the barrier is mixed with the material of the container, using co-injection techniques.

68. A container as claimed in claim 47, wherein the material contains one or more oxygen scavengers.

69. A container as claimed in claim 68 wherein the oxygen scavenger is selected from a group consisting of X-312, Amosorb 3000, or a scavenger of MXD6 with metal catalysed oxygen reduction chemistry.

70. A container as claimed in claim 47 having an inorganic coating.

71. A container as claimed in claim 70 wherein the inorganic layer is a thin layer of amorphous carbon.

72. A container as claimed in claim 70, wherein the inorganic coating is applied to the inside surface of the container.

73. A container as claimed in claim 70, wherein the inorganic coating will be applied in a layer of 100 to 200 nm thickness.

74. A container as claimed in claim 47, having an external organic coating.

75. A container as claimed in claim 74 wherein the external organic coating is PVDC or a two component epoxyamine.

76. A container as claimed in claim 47, manufactured from multiple layers of the material.

77. A container as claimed in claim 47, wherein the material includes one or additives selected from the group consisting of W inhibitors, antioxidants, flow modifiers, colour pigments and brighteners as known in the art.

78. A container as claimed in claim 51, wherein the glass transition temperature is elevated as the amorphous thermoplastic polymer is mixed with the one or more low molecular weight hydrocarbons.

79. A container as claimed in claim 51 wherein the material has a glass transition temperature of above 80° C.
